(19) United States
(12) Patent Application Publication
(10) Pub. No.: US 2022/0276982 A1
(43) Pub. Date: Sep. 1, 2022

(54) Interconnected Dies, Interconnected Microcomponents, Interconnected Microsystems and Their Communication Methods

(71) Applicant: 58th Research Institute of China Electronics Technology Group Corporation, Wuxi, Jiangsu (CN)

(72) Inventors: Jinghe Wei, Wuxi, Jiangsu (CN); Letian Huang, Wuxi, Jiangsu (CN); Zongguang Yu, Wuxi, Jiangsu (CN); Ziren Wang, Wuxi, Jiangsu (CN); Guozhu Liu, Wuxi, Jiangsu (CN); Wenxu Cao, Wuxi, Jiangsu (CN)

(21) Appl. No.: 17/626,818

(22) PCT Filed: Dec. 16, 2021
(86) PCT No.: PCT/CN2021/138696

§ 371 Date: Jan. 13, 2022

(30) Foreign Application Priority Data
Feb. 5, 2021 (CN) 202110159846.X

(51) Int. Cl. G06F 15/173; G06F 9/30

(52) U.S. Cl. CPC G06F 15/17325; G06F 15/17343; G06F 9/30087

(57) ABSTRACT

The invention discloses connections among dies, in particular to interconnected dies, comprising: protocol conversion circuits, external interconnected interfaces and networks on die. The protocol conversion circuits comprise multiple protocol conversion modules which are used to communicate with various standard mainstream protocol interfaces. The external interconnected interfaces comprise several synchronization controllers which are used to communicate with other interconnected dies. The networks on die comprise transmission buses and routers which are used to transmit data packets from the interfaces or other interconnected dies. At the same time, the synchronization controllers and the protocol conversion modules are respectively connected with boundary nodes of the networks on die. The interconnected dies support interface expansion and inter-chip cascades, hardware circuits are simple and functional levels are clearly divided, with good expandability, which overcomes the defects of closed technology, numerous and jumbled systems and bad expandability of the current multi-die systems.

### BACKGROUND OF THE INVENTION

### 1. Field of the Invention

The invention relates to connections among dies, in particular to interconnected dies, interconnected microcomponents, interconnected microsystems and their communication methods.

### 2. Description of the Related Art

With the development of digital integrated circuits, systems on chip (System on Chip, SoC, referring to integrate multiple functional modules onto one same silicon chip) have almost become the necessary scheme of realizing high-performance systems, and manufacturers satisfy the requirements of users for product performance by continuously expanding the scale of SoC. However, limited by processing technology and other factors, Moore's law (namely the rule that the number of transistors which can be accommodated on integrated circuits doubles about every 24 months) is gradually losing efficacy, which makes costs and development periods become extremely high to expand the scale of integrated circuits on a single silicon chip.

Future integrated circuits will develop towards multi-die integration, namely interconnecting and assembling multiple verified and unpackaged chip components with various functions and packaging them as a whole chip in one same package, thus forming the network on package (Network on Package, NoP). These dies can adopt different technologies, from different manufacturers, so the development period and difficulty are greatly shortened and reduced.

When establishing NoP the interconnection of multi-die faces two key problems: speed and expandability.

The current conventional inter-chip interconnection technology belongs to board level interconnection, with slow speed, and the performance quickly decreases when accessing high bandwidth resources; and now the multi-die interconnected system adopted by foreign enterprises mainly uses the proprietary protocol, so the whole system is controlled by a single manufacturer, with numerous and jumbled systems and bad expandability.

### SUMMARY OF THE INVENTION

To solve the above problems, the invention provides a highly expansible interconnected dies adopting interconnection on package and high-performance networks on chip, overcoming the defect that the traditional board level interconnection transmission bandwidth is small, and specific technical schemes are as follows:

interconnected dies, comprising: protocol conversion circuits, external interconnected interfaces and networks on die. The protocol conversion circuits comprise multiple protocol conversion modules which are used to communicate with various standard mainstream protocol interfaces. The external interconnected interfaces comprise several synchronization controllers which are used to communicate with other interconnected dies. The networks on die comprise transmission buses and routers which are used to transmit data packets from the interfaces or other interconnected dies. At the same time, the synchronization controllers and the protocol conversion modules are respectively connected with boundary nodes of the networks on die.

Further, basic management units are also comprised, and the basic management units comprise: clock management units, and the clock management units are used to convert the external clock input into operation clocks of each part inside chips; and configuration management units, and the configuration management units are used to configure the initialization information of each part inside chips when initializing systems.

Interconnected microcomponents, comprising: the interconnected dies; and functional dies, the functional dies are not less than one, and the functional dies are connected with the expansible high-speed interconnected dies by the protocol conversion circuits.

Interconnected microsystems, comprising: the interconnected microcomponents which are not less than two; and external expansion buses, the interconnected microcomponents are connected with each other by the external interconnected interfaces and the external expansion buses, and the connections also adopt topological structures.

Communication methods of the interconnected microsystems, wherein transmission methods among components and transmission methods across components are comprised: the transmission methods among components comprise that data are from a protocol conversion module into networks on die and then into another protocol conversion module through the networks on die; the transmission methods across components comprise that data are transmitted through the external expansion buses managed by the synchronization controllers.

The invention possesses the following beneficial effects compared to the current technology:

the interconnected dies provided by the invention support interface expansion and inter-chip cascades, hardware circuits are simple and functional levels are clearly divided, with good expandability, which overcomes the defects of closed technology, numerous and jumbled systems and bad expandability of the current multi-die systems, and high-performance networks on chip is adopted as the data transmission tool, so compared to the bus system transmission bandwidth is large, the adaptability of multiple cores is strong and networks are easy to expand, which can to a great degree use and support the current standard mainstream protocol interfaces, with good compatibility, and effectively reduce development costs and development periods.

### BRIEF DESCRIPTION OF THE DRAWINGS

FIG. 1 is a structural schematic diagram of the interconnected dies;

FIG. 2 is a structural schematic diagram of the interconnected microcomponents in embodiment 3;

FIG. 3 is a structural schematic diagram of the interconnected microsystems in embodiment 4.

### DESCRIPTION OF EMBODIMENTS

A further description of the invention is given in combination with the attached drawings.

### Embodiment 1

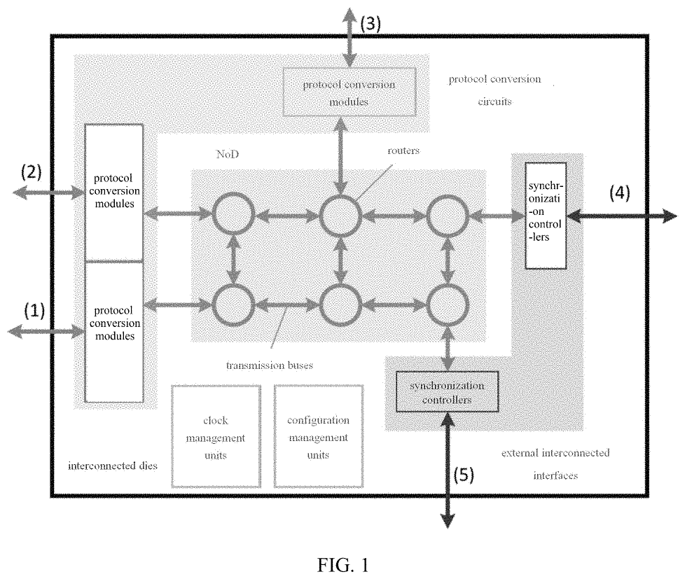

As FIG. 1 shows, interconnected dies, comprising: protocol conversion circuits, external interconnected interfaces and networks on die. The protocol conversion circuits comprise multiple protocol conversion modules which are used to communicate with various standard mainstream protocol interfaces. The external interconnected interfaces comprise several synchronization controllers which are used to communicate with other interconnected dies. The networks on die comprise transmission buses and routers which are used to transmit data packets from the interfaces or other interconnected dies. At the same time, the synchronization controllers and the protocol conversion modules are respectively connected with boundary nodes of the networks on die.

The transmission buses and routers constitute the mesh topology.

The interconnected dies are comprised of three parts of the networks on die (Network on Die, NoD), the protocol conversion circuits and the external interconnected interfaces.

NoD is used for data routes and high-speed transmission.

The protocol conversion circuits provide various standard mainstream protocol interfaces connected with the exterior, and the protocol conversion circuits comprise multiple protocol conversion modules to convert NoD protocols into mainstream protocols, used to connect other functional dies.

The external interconnected interfaces mainly comprise a couple of synchronization controllers, and the external interconnected interfaces are controlled by synchronization controllers to realize the data transmission of different clock domains inside and outside the dies.

The external interconnected interfaces and each conversion module of the protocol conversion circuits are respectively connected with a boundary node of NoD, thus to form data transmission paths.

The expansible high-speed interconnected dies proposed by the invention can realize the expansion of the interconnected dies on other mainstream functional dies and the cascades among the interconnected dies, with good expandability, which overcomes the defects of closed technology, numerous and jumbled systems and bad expandability of the current multi-die systems.

The interconnection on package and high-performance networks on chip are adopted to overcome the defect that the traditional board level interconnection transmission bandwidth is small and solve the problem of bad expandability of the current multi-die systems.

As FIG. 1 shows, the NoD comprises transmission buses and routers, manly used to transmit data packets from the interfaces or other interconnected dies. The external interconnected interfaces are the communication interfaces between the interconnected dies and other interconnected dies, easy for the expansion and cascades of systems. The external interconnected interfaces mainly comprise a couple of synchronization controllers, and they need synchronization controllers to control and realize communications because the interior and exterior of the interconnected dies usually work in the clock domains with different frequencies. (4) and (5) in FIG. 1 are the external expansion buses of the interconnected dies.

The protocol conversion circuits convert the NoD protocols into some mainstream communication protocols such as DDR (Double Data Rate SDRAM, a dynamic data memory, here referring to the data communication protocols adopted by this device), SPI (Serial Peripheral Interface), PCIe (Peripheral Component Interconnect express, a high-speed serial computer expansion bus standard) and so on, which is easy to expand some universal and mature functional dies. (1), (2) and (3) in FIG. 1 are respectively three different protocols obtained by conversions.

The advantages of adopting the above interconnected dies are as follows:

1. The interconnected dies support interface expansion and inter-chip cascades, hardware circuits are simple and functional levels are clearly divided, with good expandability, which overcomes the defects of closed technology, numerous and jumbled systems and bad expandability of the current multi-die systems.

2. The interconnected dies adopt high-performance networks on chip as the data transmission tool, so compared to the bus system transmission bandwidth is large, the adaptability of multiple cores is strong and networks are easy to expand

3. The interconnected dies can to a great degree use and support the current standard mainstream protocol interfaces, with good compatibility, and effectively reduce development costs and development periods.

### Embodiment 2

Based on the above embodiment 1, as FIG. 1 shows, the interconnected dies also comprise basic management units, and the basic management units comprise: clock management units, and the clock management units are used to convert the external clock input into operation clocks of each part inside chips; and configuration management units, and the configuration management units are used to configure the initialization information of each part inside chips when initializing systems.

The basic management units comprise clock management units and configuration management units (Configuration Management Unit, CMU), and the two are both independent of the expansible high-speed interconnected dies, the former is used to convert the external clock input into operation clocks of each part inside chips, and the latter is used to configure the initialization information of each part inside chips when initializing systems.

### Embodiment 3

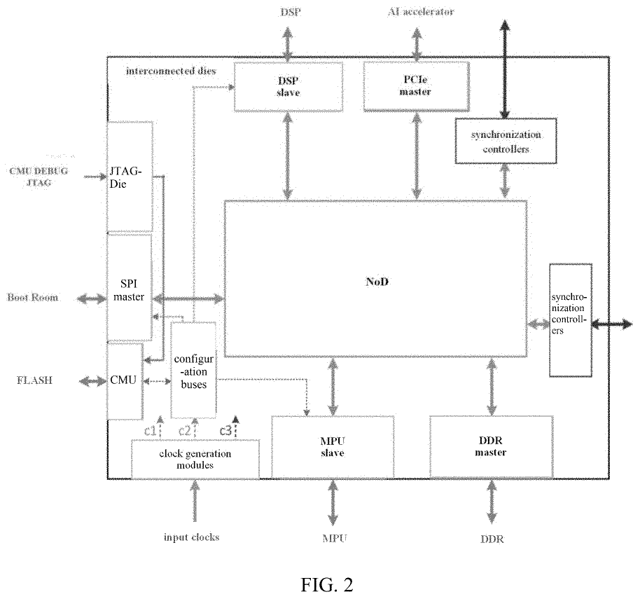

As FIG. 2 shows, interconnected microcomponents, comprising: the interconnected dies; and functional dies, the functional dies are not less than one, and the functional dies are connected with the expansible high-speed interconnected dies by the protocol conversion circuits.

The functional dies can be functional modules in random die forms, and the functional dies comprise MPU, DDR, DSP, FPGA, BOOT ROM and one or more of accelerators.

The interconnected dies proposed by the invention are assembled with various functional dies by the protocol conversion circuits to constitute microcomponents. These functional dies can be MPU (Micro Processing Unit), DDR, DSP (Digital Signal Proccesor), FPGA (Field Programmable Gate Array), BOOT ROM (Read-only Memory for System Boot) and some proprietary accelerators such as the artificial intelligent (AI) accelerator and so on.

### Embodiment 4

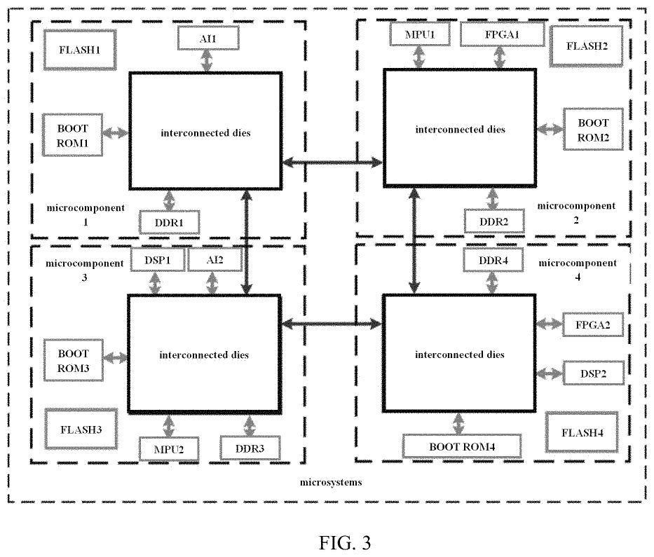

As FIG. 3 shows, interconnected microsystems, comprising: the interconnected microcomponents which are not less than two; and external expansion buses, the interconnected microcomponents are connected with each other by the external interconnected interfaces and the external expansion buses, and the connections also adopt topological structures.

The multiple microcomponents are connected with each other by the external interconnected interfaces of the interconnected dies to constitute microsystems.

The expansion, cascade methods and data transmission methods of the interconnected dies is the three-level system structure of interconnected dies-microcomponents-microsystems.

The interconnected dies are assembled with various functional dies by the protocol conversion circuits to constitute microcomponents, and the multiple microcomponents are connected with each other, by the external interconnected interfaces of the interconnected dies and by adopting certain topologies, to constitute microsystems.

The interior data transmission of the dies need start from a protocol conversion interface into NoD and then into another protocol conversion interface through routes. The data transmission across dies need pass through external interconnected buses managed by the synchronization controllers.

### Embodiment 5

Communication methods of the interconnected microsystems, wherein transmission methods among components and transmission methods across components are comprised:

the transmission methods among components comprise that data are from a protocol conversion module into networks on die and then into another protocol conversion module through the networks on die;

the transmission methods across components comprise that data are transmitted through the external expansion buses managed by the synchronization controllers.

Particularly, as FIG. 1 and FIG. 2 show, the microsystem comprised of four microcomponents is illustrated.

The microsystem comprise four microcomponents and microcomponents are connected with each other by circular topological structures. AI1 (referring to AI accelerator, the same below), BOOTROM1 and DDR1 (here DDR1 refers to ID mark number of DDR in the system, rather than DDR version and model, the same below) are mounted on the interconnected dies of the microcomponent 1, and MPU1, FPGA1, BOOTROM2 and DDR2 are mounted on the interconnected dies of the microcomponent 2, DSP1, AI2, BOOTROM3, MPU2 and DDR3 are mounted on the interconnected dies of the microcomponent 3, and DDR4, FPGA2, DSP2 and BOOTROM4 are mounted on the interconnected dies of the microcomponent 4.

As FIG. 3 shows, five protocol conversion modules are provided in the interconnected die of the microcomponent 3 and conversions from the NoD protocols into DSP protocols, PCIe, SPI, MPU protocol and DDR are respectively realized, thus as the interconnected die to access the interfaces of DSP1, AI accelerator 2, BOOTROM3, MPU2 and DDR3. The two synchronization controllers in the interconnected die respectively manage two external interconnected buses, and the two buses are respectively connected with the microcomponent 1 and the microcomponent 4 to realize the interconnections among the microcomponents. In addition, the interior clock generation module (or clock management unit) of the interconnected die receives the external clock input, and convert it into three clocks of c1, c2 and c3, respectively used to drive three functional parts of the protocol conversion circuit, the NoD and the external interconnected interface. The interior CMU of the interconnected die is connected with the external FLASH, FLASH stores the system initialization information, and when the system boots, CMU transmits the initialization information into each protocol conversion interface by configuration buses to realize the system initialization.

When the system works, its data transmission methods can be divided into two situations: transmission among components and transmission across components. For the transmission among components such as the data transmission from MPU2 to DDR3 in the microcomponent 3, the data are from MPU2 into a boundary node of NoD through the MPU protocol conversion interface, then into anther boundary node through multiple routes among NoD nodes and then into the DDR protocol conversion interface through this node, finally transmitted into DDR3. For the transmission across components such as the data transmission from FPGA1 in the microcomponent 2 to AI2 in the microcomponent 3, the data are from FPGA1 into NoD through the FPGA protocol conversion circuit in the microcomponent 2, then into network nodes connected with one synchronization controller through routes, then into the external interconnected interface of the interconnected die in the microcomponent 4 through the external interconnected interface controlled by the synchronization controller, then into the NoD of the die under the control of the synchronization controller, then into the network nodes connected with the other synchronization controller through routes, then into the interconnected die in the microcomponent 3 through the external interconnected interface, finally into the protocol conversion interface connected with AI2 through the route of NoD, thus transmitted into AI2. In addition, the data transmission of adjacent microcomponents and across multiple microcomponents is similar to this, so no more detailed description is given here.

The technical principles of the invention are described above in combination with specific embodiments. The descriptions are only for explaining the invention principles and shall not be explained in any way as limitations to the protection scope of the invention. Based on the explanation, without doing the creative work, technicians in the field can make an association with other specific embodiments of the invention, which shall all fall within the protection scope of claims of the invention.

1. Interconnected dies, comprising:
protocol conversion circuits, external interconnected interfaces and networks on die;
the protocol conversion circuits comprise multiple protocol conversion modules which are used to communicate with various standard mainstream protocol interfaces;
the external interconnected interfaces comprise several synchronization controllers which are used to communicate with other interconnected dies;
the networks on die comprise transmission buses and routers which are used to transmit data packets from the interfaces or other interconnected dies. At the same time, the synchronization controllers and the protocol conversion modules are respectively connected with boundary nodes of the networks on die.

2. The interconnected dies according to claim 1, wherein,
basic management units are also comprised, and the basic management units comprise:
clock management units, and the clock management units are used to convert the external clock input into operation clocks of each part inside chips; and
configuration management units, and the configuration management units are used to configure the initialization information of each part inside chips when initializing systems.

3. Interconnected microcomponents, comprising:
the interconnected dies according to claim 1; and
functional dies, the functional dies are not less than one, and the functional dies are connected with the expansible high-speed interconnected dies by the protocol conversion circuits.

4. Interconnected microsystems, comprising:
the interconnected microcomponents according to claim 3 which are not less than two; and
external expansion buses, the interconnected microcomponents are connected with each other by the external interconnected interfaces and the external expansion buses, and the connections also adopt topological structures.

5. Communication methods of the interconnected microsystems, wherein,
transmission methods among components and transmission methods across components are comprised:
the transmission methods among components comprise that data are from a protocol conversion module into networks on die and then into another protocol conversion module through the networks on die;
the transmission methods across components comprise that data are transmitted through the external expansion buses managed by the synchronization controllers.
